(19) United States
(12) Patent Application Publication
(10) Pub. No.: US 2014/0156906 A1
(43) Pub. Date: Jun. 5, 2014

(54) Virtual Trunking Over Physical Links

(71) Applicant: BROADCOM CORPORATION, Irvine, CA (US)

(72) Inventors: Biju Babu, San Jose, CA (US); Mohan Kalkunte, Saratoga, CA (US)

(73) Assignee: BROADCOM CORPORATION, IRVINE, CA (US)

(21) Appl. No.: 13/766,629

(22) Filed: Feb. 13, 2013

Related U.S. Application Data
(60) Provisional application No. 61/732,236, filed on Nov. 30, 2012.

(51) Int. Cl. G06F 13/40

(52) U.S. Cl. CPC G06F 13/4022
USPC 710/316

(57) ABSTRACT

A technique in which at least one controlling bridge controls data traffic among devices located lower in hierarchy below the controlling bridge. Those devices include a plurality of porting devices, such as line modules and port extenders, which ultimately communicate with an end point device, referred to as a station. At least two physical pathways from a controlling bridge to a station are grouped together into a virtual trunk to provide multiple physical pathways for packet transfer when operating in a dual-homed mode.

### CROSS REFERENCE TO RELATED APPLICATION

This application claims the benefit of priority under 35 U.S.C. 119(e) to U.S. Provisional Patent Application No. 61/732,236, filed Nov. 30, 2012, which is incorporated herein by reference in its entirety for all purposes.

### BACKGROUND OF THE INVENTION

1. Technical Field of the Invention

The embodiments of the invention relate to wired communications and, more particularly, to connecting a bridging device to various intermediate routing and endpoint devices within the wired network.

2. Description of Related Art

Various wired communication systems are known today to provide communication links between devices, whether those devices are endpoint devices, intermediate routing devices or bridging devices. The communication may be among devices within a given network or connections may be established across networks. In one particular type of system, a bridging device is utilized to control the data traffic between those components that reside on one side of the bridge (e.g. downlink) and those components or network that reside on the other side of the bridge (e.g. uplink). An example of a bridging system is an enterprise system, in which a bridge controls data traffic among a plurality of components that reside hierarchically below the bridge, as well as data flow between the bridge and an environment that resides hierarchically above the bridge.

An example prior art data transfer system that uses physical links is illustrated in FIG. 1. The diagram of FIG. 1 shows a system block diagram of a system 100, in which only the high level connectivity is illustrated. System 100 includes a controlling bridge (CB) 101 that communicates with a plurality of line modules (LM) 102 that are located downlink from CB 101. In the particular example of system 100, eight line modules LM0 to LM7 are shown. Each line module 102 further couples to devices downstream. One such device is shown coupled to LM0. An endpoint device 103 is shown coupled to LM0. Note that, although not illustrated, the various LMs 102 would have connections to endpoint devices as well. In one application for data networks employing a controlling bridge, the endpoint devices are referred to as virtual machines or VMs. Thus, endpoint device 103 is a VM coupled downstream from LM0 in FIG. 1.

The data transfer for system 100 is controlled by CB 101. For example, if endpoint device 103 wants to transfer data to another endpoint device within system 100, the data is first transferred from endpoint device 103 to LM0. Then, LM0 transfers the data to CB 101 under arbitration control provided by CB 101. CB 101 receives the data and using the destination address accompanying the data, identifies the destination endpoint device. CB 101 then transfers the data to an LM associated with the endpoint device and subsequently sends the data to the destination endpoint device. Alternatively, if the data from endpoint device 103 is destined for a location outside of system 100, then CB 101, upon receiving the data from LM0 will send the data uplink to a device, component and/or network that resides high up in the hierarchy from CB 101.

Generally, the data transfer is achieved by utilizing a particular communication protocol. A common communication protocol to be used with a wired system, such as system 100, is a protocol specification defined by IEEE 802.1 standard. IEEE 802.1 standard applies to network management. System 100 may be configured as an Ethernet™ network, in which instance, system 100 may employ IEEE 802.3 or equivalent specification to define Media Access Control (MAC) layers for the Local Area Network (LAN).

CB 101 may utilize a single bridging device or it may use more than one bridging device. In FIG. 1, CB 101 is shown having two bridging devices CB-A and CB-B. CB-A and CB-B may operate independently or they may operate together. In FIG. 1, data lines 105 and control lines 106 are shown connecting CB-A and CB-B, so that the two bridging devices may operate together to balance the data flow. As noted, the uplink connection from CB 101 may be to other devices and/or networks that reside uplink from CB 101.

Note that in system 100, the various components 101-103 are connected by physical links that have a one-to-one connection with each other. Even though a virtual channel may be assigned to communicate between a particular VM and CB 101, the communication is passed along a single physical path. That is, data that traverses up the hierarchy from a VM or LM to CB 101 takes a defined physical path. Likewise, data traversing down the hierarchy from CB 101 to a LM or VM takes a single physical path. A break (failure) in a particular link would open the path of the physical link. Furthermore, unless alternate pathways are available, other than the single physical pathway, data load balancing may not be achievable when utilizing only a single physical path.

Accordingly, there is a need for a system that utilizes more than one physical link in designating a data path to an endpoint device for a hierarchy managed by a bridging device in a network.

### BRIEF DESCRIPTION OF THE DRAWINGS

FIG. 1 shows a prior art diagram depicting a system having a bridge, a plurality of line modules and at least one endpoint device, in which the hierarchy of the system utilizes a single physical link to transfer data between the bridge and the endpoint device.

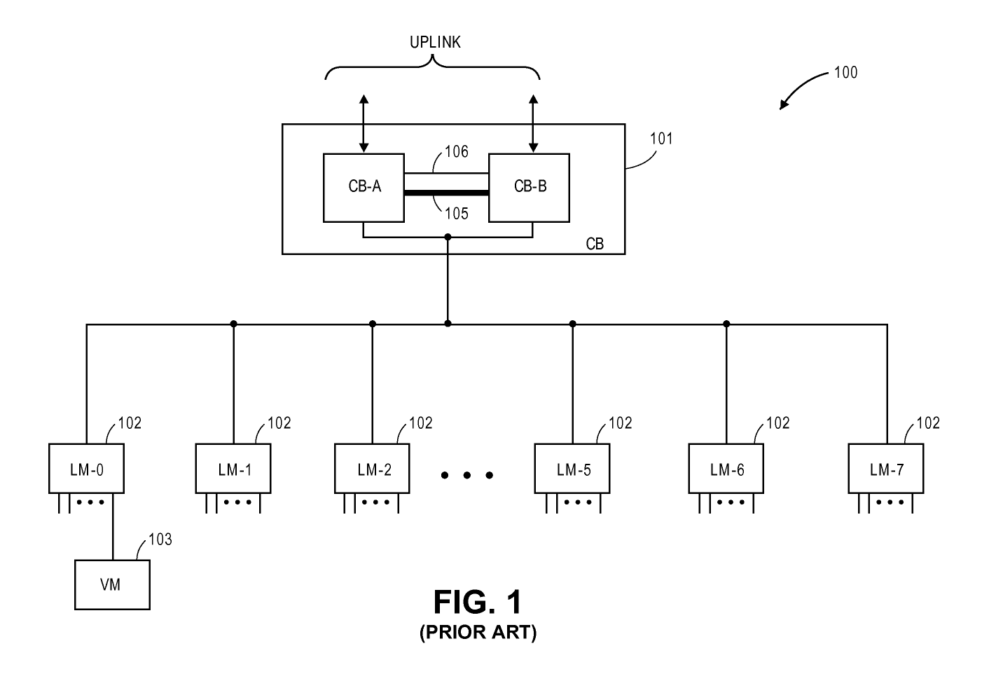

FIG. 2 shows a system block diagram in which virtual trunk lines are used over physical links to provide multiple pathways to transfer data between a controlling bridge and an endpoint device of a system, in order to provide duplicate pathways for data transfer according to one embodiment for practicing the invention.

FIG. 3 shows an example unicast data flow for the system of FIG. 2 when one physical link in a single-homed mode is used according to one embodiment for practicing the invention.

FIG. 4 shows an example ETAG format for use in data communication for the system of FIG. 2 according to one embodiment for practicing the invention.

FIG. 5 shows an example multicast data flow for the system of FIG. 2 when one physical link in a single-homed mode is used according to one embodiment for practicing the invention.

FIG. 6 shows an example unicast data flow for the system of FIG. 2 when virtual trunking of a dual-homed mode is used according to one embodiment for practicing the invention.

FIG. 7 shows an example multicast data flow for the system of FIG. 2 when virtual trunking dual-homed mode is used according to one embodiment for practicing the invention.

FIG. 8 shows a block schematic diagram illustrating a hardware device that may be used for the line module or port extender for the system of FIG. 2 according to one embodiment for practicing the invention.

FIG. 9 shows a block schematic diagram illustrating a hardware device that may be used for the controlling bridge for the system of FIG. 2 according to one embodiment for practicing the invention.

### DETAILED DESCRIPTION OF THE INVENTION

The embodiments of the present invention may be practiced in a variety of systems that employ a central or edge routing device, such as a bridging device, to transfer data. Although the embodiments are described in reference to a controlling bridge on a network, the invention may be readily implemented in other routing devices as well. The invention need not be limited to a controlling bridge. For example, switches of a switch fabric may employ the practice of the present invention. Likewise, devices other than line modules, line cards, porting components, port extenders that are described herein may be used to practice the invention as well. Furthermore, the embodiments of the invention are described in reference to protocols or specifications defined under one of IEEE 802.# standard or protocol (such as IEEE 802.1, IEEE 802.2, IEEE 802.3 etc.), but need not be limited to such standards or protocols. Additionally, the embodiments of the invention are described in reference to physical links in a wired environment. However, other embodiments may use wireless links or incorporate a system in which portions of the system may have wireless communication links. Thus, the physical links described herein and illustrated in the Figures reference wired connections, but it is to be noted that wireless communication pathways, or a combination of wired and wireless pathways may be employed in other embodiments.

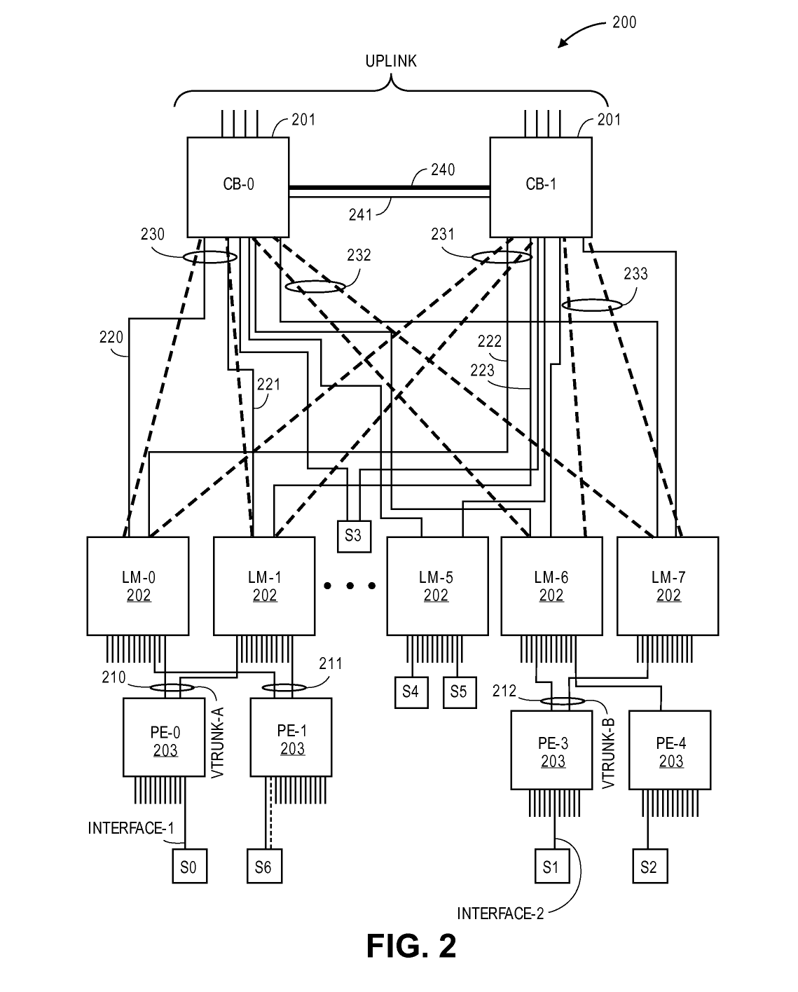

FIG. 2 shows a block diagram of a system 200 that includes a plurality of Controlling Bridges (CBs) 201, Line Modules (LMs) 202 and Port Extenders (PEs) 203. System 200 shows two CBs 201 (noted as CB0 and CB1). It is to be noted that other embodiments may have more than two CBs. CBs 201 communicate with each other to transfer data and control information between CBs via data bus 240 and control lines 241. CBs 201 communicate with the plurality of LMs 202, which are disposed downlink from CBs 201. Eight LMs (noted as LM0 to LM7) are noted for system 200, but other embodiments may have more or less number of LMs 202. LMs 202 in the embodiment of system 200 are located one level below CBs 201 in the hierarchical arrangement for system 200. A given LM 202 provides an interface between CBs 201 and components and devices that reside downstream from that LM 202, so that the LMs essentially operate as extended ports.

Below the system hierarchy of LMs 202 are PEs 203, which provide the function of increasing (e.g. extending) the number of components that may be connected to each LM 202. For example, if an LM 202 had “N” downstream lines, it may connect to “N” endpoint devices or end stations (or stations). However, by utilizing a PE on each LM line, the number of endpoint stations that may connect through that LM is multiplied. For example, if the particular LM with “N” downstream lines connected each line to a PE that has “M” downstream lines, then potentially N×M stations may connect through a LM/PE combination to the CB. It is to be noted that each PE 203 may be extended further by having another PE or PEs located farther downstream from the first PE. Although the variations of such hierarchical structure are numerous, the main gist of the embodiments of the invention is identified in FIG. 2 and described below. Note that in FIG. 2, four PEs are shown (noted as PE0, PE1, PE3 and PE4). Furthermore, note that in some instances, a station may couple directly to a LM or even to a CB without utilizing a LM 202.

Thus, for the particular structure shown in system 200, CB0 and CB1 are coupled to the LMs (LM0 through LM7), as well as to each other, so that data transfer may occur between a particular CB and a particular LM. Likewise, each LM 202 may couple downstream to a station, PE 203, or some other device or component. As noted above, a given station may couple directly to a LM 202 (as shown by station S4 and S5 coupling to LM5) or even to a CB 201 (as noted by station S3). In one embodiment, system 200 utilizes one or more of the IEEE 802.# standard or protocol (such as IEEE 802.1, IEEE 802.2, IEEE802.3, etc.) to communicate with each other and to transfer data within system 200. Furthermore, the data may be sent uplink from CBs 201, or data received from the uplink into CB 201. In one embodiment, an Ethernet LAN provides the uplink connection for CB 201. However, other protocols, standards, and/or specification may be used in other embodiments. Generally, at boot-up initiation, when devices are added, or during other conditions, the various devices/components of system 200 are identified in the system and the CBs retain the pre-configuration information for system 200.

System 200 may operate as a single-homed system, a dual-homed system or a combination of both single-homed and dual-homed. When operating in a single-homed mode, the physical links coupling a particular station to a CB has a singular physical path up the hierarchy to a designated CB 201. When operating in a dual-homed mode, there are two alternate paths from a particular station to the two CBs. The dual-homed pathway is routed through two different intermediary routing devices. A combination system would employ both single and dual routing schemes. As will be described later in the description, for the dual-homed system, the CBs may establish and maintain a virtual connection (termed “virtual trunk” or “virtual channel” herein) over two different physical pathways (links) to the station, so that the data transfer may be achieved over either or both of the two physical links.

In the example embodiment of FIG. 2, station S0 couples to PE0 utilizing a single connection (link), noted as Interface-1, and station S1 couples to PE3 utilizing a single connection noted as Interface-2. Station S6 couples to PE1 using a single connection link and station S2 couples to PE4 using a single connection. At the PE level, PE0 is shown having a connection to LM0 and LM1. It is to be noted that PE0 may couple to more PEs in other embodiments. Likewise PE1 is shown coupled to LM0 and LM1. PE3 couples to LM 6 and LM7. On the other hand, PE4 is shown coupled only to LM6. Since in the embodiment of FIG. 2, the LMs have separate connections to CB0 and CB1, PE0, PE1 and PE3 have dual paths to either CB. However, PE4 does not have a complete dual path to the CBs, since PE4 has a single path through LM6 only.

Accordingly, stations may establish a dual path from the station to the CBs utilizing different LMs, while other stations (e.g. station S2) may establish a path only through a single LM. Furthermore, note that stations S0, S1, S2 and S6 are shown having a single path between the station and the corresponding PE, but in other embodiments an interface coupling an end station to a PE may have multiple links. Such multiple link coupling of the station allows for duplicity in the connection of the end station. Thus, dashed lines at station S6 in FIG. 2 shows a potential second link in the interface coupling S6 to PE1.

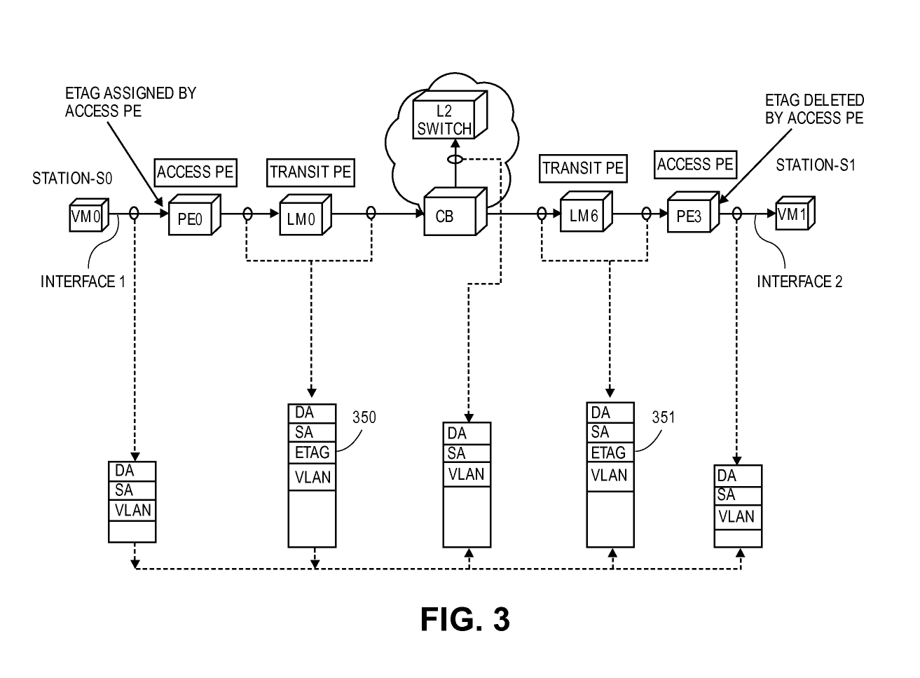

In the description below pertaining to FIGS. 3, 5, 6 and 7, a single-homed mode and a dual-homed mode is described. The single homed-mode pertains to a mode where a single physical path is available or a single physical path is configured for use in reaching the last PE that connects to a station, or the end station itself. The dual-homed mode pertains to a mode where dual physical paths are available or a dual physical paths are configured in reaching the last PE that connects to a station, or the station itself. It is to be noted that FIG. 2 shows only one PE level in the hierarchy, but other embodiments may use multiple PE levels.

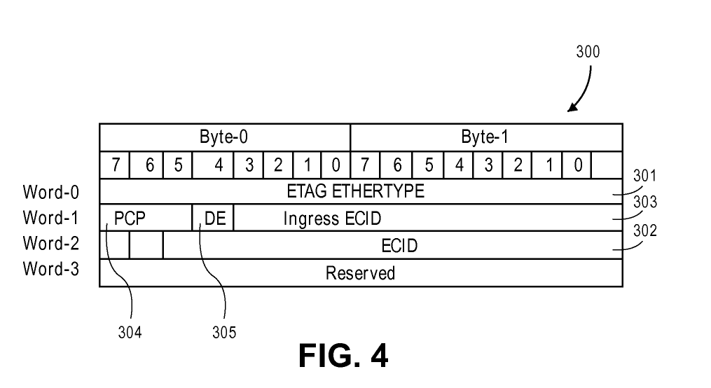

FIG. 3 illustrates a single-homed mode of operation for unicast data flow from one station to another station. In the example, station S0 (noted as Virtual Machine 0, or VM0) generates packet data for unicast transmission to station S1 (VM1), via one of the CBs. In some instances, the connection may be to an interface coupled to a virtual station, designated as a Virtual Station Interface (VSI) and may be coupled to an edge relay. The packet contains the Media Access Control (MAC) source address (SA) of station S0 to identify the source of the packet data and a MAC destination address (DA) to identify the destination of the packet, which is station Si in the example. A Virtual LAN (VLAN) identifier may also be included if the stations operate within a Virtual LAN. Assuming that station S0 is coupled to PE0 (via Interface1), PE0 then assigns a tag to the packet. Although a variety of tags may be assigned to the packet, FIG. 4 shows one format referred to as an E-channel tag (ETAG) that may be used with Ethernet communications.

ETAG 300 shown in FIG. 4 uses a format specified by an IEEE 802.# specification, such as IEEE 802.1BR, which provides for bridge port extensions. In the format, ETAG Ethernet field 301 defines the IEEE 802.3 type field that is used to determine that a frame is carrying an ETAG. An E-channel identifier (ECID) field 302 identifies the downstream interface (e.g. VM/VSI) associated with the frame. For the packet going upstream, ECID field 302 identifies the source VM/VSI. An ECID value may also indicate if the transmission is unicast or multi-cast. In one embodiment, which pertains to the use of IEEE 802.1 BR, ECID values below 4096 are used for unicast destinations, while values in the range 4096-16383 represent multicast replication tree identifiers. Note that other embodiments may use other values than those noted above.

An Ingress ECID field 303 is used for a pruning function to ensure that the data is not sent back toward the sender in the same namespace within the hierarchy. Ingress ECID is valid only for downstream packet flow and identifies the VM/VSI where the packet originated. If the source VM/VSI and destination VM/VSI are in the same name space domain, the packet does not transition back down to the source. Although not relevant to the understanding of the present invention, ETAG format 300 also includes a Priority Code Point (PCP) field 304 and a Discard Eligibility (DE) field 305. PCP is used to contain a value to differentiate traffic and DE is used to indicate if the frame may be dropped when congestion is experienced.

Referring to FIG. 3 again, an example packet flow is illustrated. Assuming station S0 is operating in a single-homed mode, unicast packet from station S0 is sent to station S1 through PE0, which functions as an access PE. PE0 is coupled to LM0, in which LM0 functions as a transit PE to carry the traffic upstream from S0 (VM0) to one of the CBs. In the single-homed mode, only one LM is selected. The CB functions as the central network policy management entity for system 200 and performs the forwarding function to transfer the packet traffic to LM6. LM6 and PE3 carry traffic downstream to station S1, which is also noted as VM1. In the single-homed mode, only one LM (e.g. LM6) used in the path between the CB and PE3. Note that the PEs that interface to the stations are referred to as access PEs (APEs), while other intermediate PEs are referred to as transit PEs (TPEs). Note that a LM may be an APE or a TPE, depending on where the station connections are made. In the shown example, LMs functions as TPEs. APEs assign ETAGs based on the ingress port, while TPEs do not assign ETAGs.

For upstream traffic flow, PE0 is responsible for assigning an ingress port based ETAG 350 to the packet. The ECID (ETAG.ECID) identifies the source station (S0 in the example) of the packet. PE0 also populates PCP and DE fields of the ETAG. The Ingress ECID field is set to “0”. Packets ingressing with ETAG.ECID=0 are to be treated as non-ETAG packets (and will be assigned an ingress Port based ETAG), except that the incoming PCP/DE values are to be retained.

PE0 forwards the traffic received on the downstream port to a pre-configured upstream port. The packet typically does not undergo a level 2 (L2) or level 3 (L3) lookup or learning. LM0 expects all incoming packets at a downstream port to have an ETAG, so that the Ingress ECID field is not looked at by LM0. LM0 then performs a Reverse Path Forwarding (RPF) check based on the incoming ETAG's ECID field. This check is performed to make sure that incoming ECID is known and resident in the downstream port. LM0 then forwards traffic received on the downstream port to a pre-configured upstream port. The packet doesn't undergo L2 and/or L3 (L2/L3) lookup or learning.

Subsequently, when the CB receives the packet from LM0, the CB uses {ingress port, ETAG.ECID} to identify the station that originated the packet (S0 in this case). Any policies for traffic from S0 are applied. CB also learns the association between {MACSA, VLAN} and {ingress port, ETAG.ECID}. CB then performs the L2/L3 forwarding lookups on the packet's {MACDA, VLAN}, in which event the result could either be a local station on network 200 or a destination that is reachable through CB's Ethernet uplink through L2 switch coupled to the CB. The L2/L3 lookup or learning is designated by a switch, shown as L2 switch in FIG. 3. If the packet is destined for the uplink, such as an Ethernet uplink, then the forwarding lookup result is just an egress port. The ETAG is deleted and the packet is sent to the Ethernet uplink. If the destination is a local station (which is the case in the example) the forwarding lookup results in {egress port, egress ETAG.ECID}.

As shown in FIG. 3, the downstream packet flow is to station S1 via LM6 and PE3. For the packet going downstream, the ECID identifies the destination station (VM or VSI). If the egress port had happened to be the same as the ingress port, then the packet is sent back into the same namespace domain. The Ingress-ECID of the ETAG is populated with incoming ETAG.ECID. Then Egress ETAG.ECID is assigned from the forwarding lookup. If the egress port is different from the ingress port, then the packet is destined to a different namespace domain, so that the Ingress ECID field is set to “0”. Egress ETAG.ECID 351 is assigned from the forwarding lookup at the CB.

For the downstream traffic from the CB, the downstream TPE (LM6 in this example) expects packets from the CB to contain ETAG 351. LM6 drops and copies to its processing circuitry all non-ETAG'ed packets. LM6 also checks whether the format of the ETAG is correct for downstream packet flow. An RPF Check is typically performed at this point. LM6 then forwards the packet based on a {ingress port, ETAG.ECID} lookup that results in a destination port (the downstream port to PE3). The ingress port in the key identifies the namespace (CB port) for the ECID and the packet is forwarded to PE3. PE3 also forwards the packet based on {ingress port, ETAG.VID} lookup. Since the packet is now sent to station S1 (and not another PE), PE3 deletes the ETAG from the packet before sending the packet to station S1. FIG. 3 shows relevant portions of the packet associated with packet flow in the rectangular blocks at the lower part of the Figure.

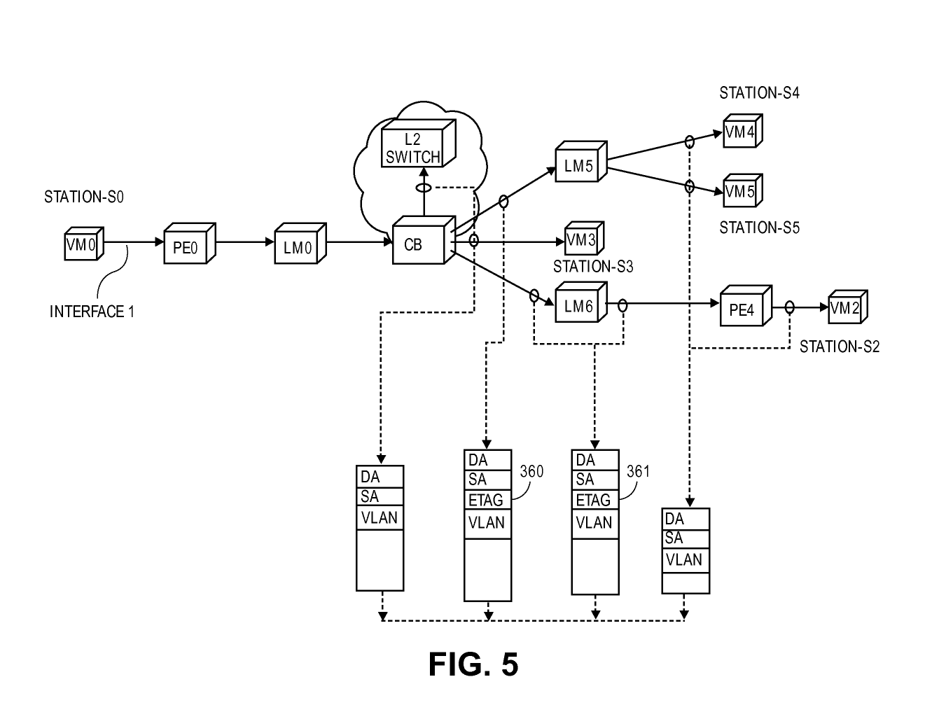

For multicast packet flow, FIG. 5 shows an example of a multicast packet traffic from station S0 to multiple destinations in a single-homed mode. The flow from station S0 to the CB is equivalent to that of the upstream traffic flow described in reference to FIG. 3, with the exception that the ECID value is indicative of a multicast transmission. For example, for IEEE 802.1 BR specified traffic, ECID values above 4096 are used for multicast destinations. In one implementation, ECID values in the range 4096-16383 represent the multicast replication tree identifiers.

In the upstream direction, all packets are first sent to the CB regardless of unicast or multicast transmissions. Each port forwards the traffic to its associated upstream port(s). As noted, when a multicast packet is received at PE0 from S0, processing is identical to the unicast case, in that an ETAG is inserted and the packet is forwarded to a pre-programmed upstream port.

At the CB, the CB does forwarding lookups based on {MACDA, VLAN} and determines the recipients for each packet. In the downstream direction, PEs are capable of doing multicast replication based on ETAG.ECID (e.g. using ECID values from 4096 to 16383 to identify that the traffic is multicast traffic). Therefore, the CB sends only one copy of the packet to each PE connected to it downstream, even if there are multiple multicast destinations coupled to a particular PE. Each downstream PE represents a single multicast replication tree with a unique multicast replication pointer. In one embodiment, a 14-bit multicast replication pointer is used. When the CB receives the packet from LM0, the CB uses {ingress port, ETAG.ECID} to identify the station that originated the packet (S0 in this case). Any policies for traffic from S0 are applied. The CB also learns the association between {MACSA, VLAN} and {ingress port, ETAG.ECID}. The CB performs L2/L3 forwarding lookups on the packet's {MACDA, VLAN}. The ETAG from the CB is shown as ETAG 360. In the instance where one or more recipients are reached via the Ethernet uplink, the ETAG for these ports is deleted and the packet is sent to the uplink port.

As shown in FIG. 5, multiple recipients are shown as destination for the multicast transmissions. The recipients may be coupled directly to the CB, as illustrated by station S3 (VM3). For those downstream ports where there are stations behind the PEs, the CB sends one copy of the packet with ETAG.ECID set to multicast distribution tree identifier. For packets going back out of the ingress port ETAG.Ingress-ECID is populated from incoming ETAG.ECID, else ETAG.Ingress-ECID is set to “0”. In the example, LM6 is a TPE, while LM5 is an APE. For packets egressing on ports connected to stations, the ETAG is deleted. Thus, for packets egressing from LM5, the ETAG is deleted and the packets are sent to stations S4 and S5 (VM4 and VMS). For these ports, LM5 also checks whether the packet originated from the same port (if ETAG.IngressECID=0 and ETAG.ECID=Port.ECID) and if so, it will not forward the packet.

For packets egressing on ports coupled to a PE, the ETAG is passed through (shown as ETAG 361). Accordingly, as illustrated in FIG. 5, LM6 passes ETAG 361 to PE4, where the ETAG is removed prior to forwarding the packet downstream to station S2 (VM2). Similar to FIG. 3, FIG. 5 shows relevant portions of the packet associated with packet flow in the rectangular blocks at the lower part of the Figure.

When system 200 of FIG. 2 is configured to operate in the dual-homed mode of operation, in one embodiment for dual-homed operation, a dual physical link is established for the single pathway used in the single-homed mode. Thus, under dual-homed mode of operation, station S0 is shown having two physical links (e.g. two separate physical pathways) from PE0 to the CBs via LM0 and LM1. In the example, one physical link couples S0 to PE0 (designated as Interface1). However, as noted above, multiple links may be used in coupling S0 to PE0 in other embodiment. The two physical paths from either or both of the CBs via LM0 and LM1 to PE0 are designated as a single Virtual Trunk (VTRUNK) for station S0 (noted as VTRUNK-A). This is shown in FIG. 2, where two physical pathways are configured from PE0 to the CBs, via different LMs. FIG. 2 also shows a second VTRUNK (noted as VTRUNK-B), where two physical links are configured between PE3 and the CBs, via two different LMs (LM6 and LM7), to connect to station S1.

Furthermore, note that PE1 may have a VTRUNK dual connection path configured for PE1 and station S6, via LM0 and LM1, as well. Note that for a dual-homed configuration, a station utilizes two different pathways to the CB from an APE device, in which the pathways is through different TPE devices.

As noted, the upstream coupling of VTRUNK-A from PE0 uses two physical links (noted by grouping 210) in FIG. 2. By using separate LMs, a failure of one LM still ensures that an alternate physical link is available upstream to the CBs. As shown, one physical link is coupled to LM1 and a second physical link is coupled to LM2. Similarly, FIG. 2 shows dual upstream connections VTRUNK-B for station S1, by using grouping 212, having one physical link to LM6 and the second physical link to LM7. PE1 may also be configured for dual-homed use, since PE1 may establish a VTRUNK by using grouping 211 to configure paths via LM0 and LM1 to the CBs.

The upstream connection from LM0 to CB0 utilizes physical link 220 and the upstream connection form LM1 to CB0 utilizes physical link 221. However, since a packet from S0 may either take the path through LM0 or LM1, two physical paths are available for upstreaming of the packet to CB0. In this way, the duplicate pathways of a VTRUNK use different intermediate routing devices/components at least at one TPE level. If one LM were to experience failure, the second path to CB0 for the dual-homed configuration is still available. Note that LM0 and LM1 may also provide the dual physical link connection on links 222 and 223, respectively, to CB1. In this way, a failure by one CB still allows a packet from S0 to be routed to its intended destination(s).

In order to associate the dual physical paths for a VTRUNK to connect to a given CB, a concept of “virtual trunking” (also may be referred to as “virtual channeling”) is implemented for physical links. When establishing the various connections in the dual-homed operation, the CBs create a VTRUNK that identifies the dual pathways for a given end station. In the example of station S0 and VTRUNK-A above, the CBs 201 set up a virtual trunk (or channel) identifying both LM0 and LM1 as downstream destinations for station S0. The virtual connection is shown as dashed lines in grouping 230. That is, grouping 230 identifies that the one virtual path known as VTRUNK-A actually has two possible downstream pathways (one each to LM0 and LM1). This information is generally retained in the CBs as part of pre-configuring the system. Thus, when a CB receives the upstream ETAG information, the CB checks to determine if the destination device connects via a virtual trunk. If so, then dual-homed technique may be applied, wherein the CB determines the VTRUNK and the downstream devices that are associated as part of that VTRUNK.

If an equivalent virtual connection is established for CB1 for VTRUNK-A, the virtual connection (shown by dashed lines of grouping 231 in FIG. 2 to identify the trunk) provides the information at CB1 that physical links 222 and 223 are applicable for VTRUNK-A to reach station S0. Whenever, LM0 or LM1 receives packet traffic destined for the station associated with a VTRUNK, the associated ETAG identifies the destination device, so that the receiving LM may then further downstream the packets to the intended destination (e.g. station S0).

A similar technique may be used with VTRUNK-B associated with station S1, in which VTRUNK (or channel) grouping 232, 233 may be used to configure LM6 and LM7 as the two downstream devices for reaching PE3 and S1. This technique may be utilized to establish a plurality of VTRUNKs, in which each of the CBs may retain the information as to which physical links from the CB is associated with the VTRUNK. In this manner, a given CB may send the packet downstream on either of the physical links, based on the provided ETAG/ECID. It is to be noted that a particular physical link or links may be designated for more than one VTRUNK.

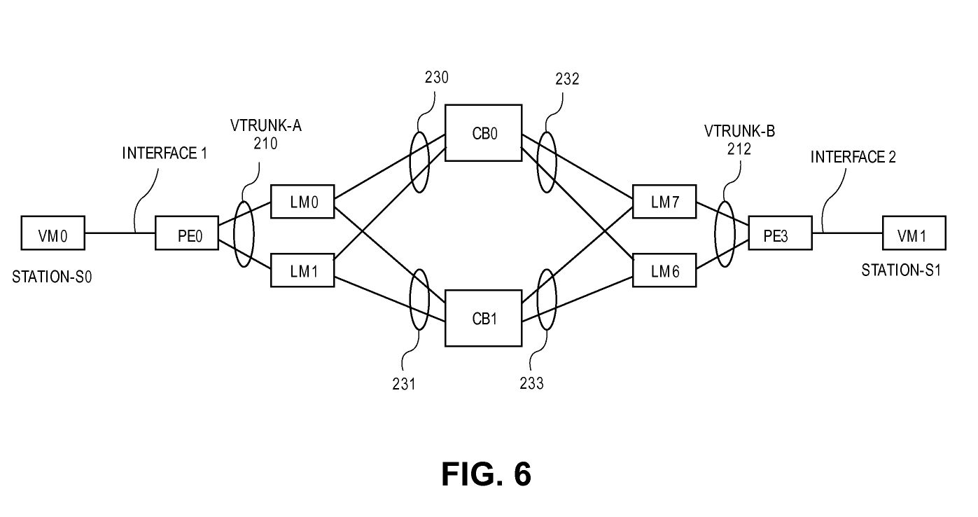

FIG. 6 illustrates an example of unicast packet flow from station S0 (VM0) to station S1 (VM1) utilizing the dual-homed virtual channel. As shown, unicast packet is sent from station S0 to PE0 on Interface1 and arrives at the downstream port PE0. PE0 adds an ETAG with an interface specific ECID value. After physical link resolution, the packet is forwarded to either LM0 or LM1 (since dual homing is enabled for PE0). Whichever LM that is selected for receiving the packet ensures that the incoming packet has the correct ETAG (i.e. ECID value is resident on the incoming port) and then forwards the packet to its upstream port(s) towards CB0 (or CB1). When the CB receives this packet it translates the {incoming-port, ECID} to {Interface1, VTRUNK-A}, since station S0 is configured for dual-homed use, and learns the Interface/VTRUNK value against packet's {MAC SA, VLAN}. A L2/L3 forwarding at the CB may then send this packet to a destination {52, VTRUNK-B} and VTRUNK-B will be resolved to a physical link connecting either to LM6 or LM7.

In FIG. 6, the forwarding is to two physical port members, one to LM6 and the other to LM7, for connection to PE3. The outgoing packet from the CB is modified to replace the ETAG with a new ECID value representing Interface2 at PE3. Physical port resolution picks either LM6 or LM7 and forwards the packet downstream. The receiving LM will check the incoming downstream packet for ETAG status and forwards the packet based on {incoming-port, ETAG.ECID} to the downstream port at PE3. PE3 does the same, and forwards the packet to Interface2 after deleting the ETAG present in the packet. Note that the dual physical links are illustrated as a grouping (circled) in FIG. 6. As noted above, a variation of the dual-homed configuration may be implemented in using a single connection between the station and its APE, such as the single connection between S6 and PE1 (shown in FIG. 2).

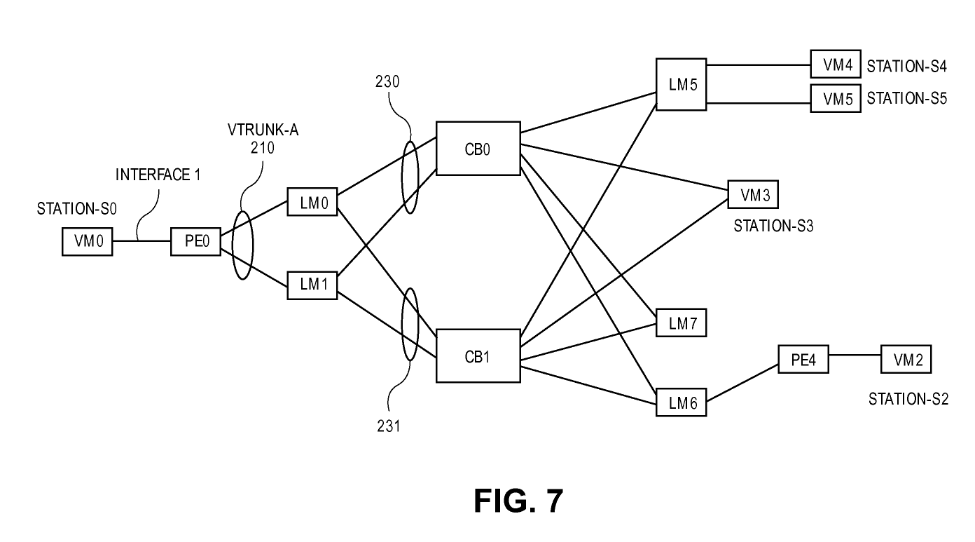

FIG. 7 illustrates an example for multicast transmission from station S0. For multicast transmissions, the packet is forwarded in the same manner as unicast packets in the upstream direction. L2/L3 forwarding processes results at the selected CB. The packet identification results in this packet being forwarded to a designated Multicast Group. The CB uses loop-free multicast replication trees rooted at the CB to reach the specific interface that is connected to the CB(s) using the VTRUNK. Outgoing packet ETAG's ECID is replaced with a multicast Tree-ID representing the downstream multicast packet replication tree. A single copy of the packet is then forwarded to an LM. The receiving LM checks incoming packet for ETAG status, and does a forwarding lookup for the packet based on {incoming-port, ETAG-ECID}, which results in a list of downstream ports that are members of the multicast replication tree. The LM replicates the packet and a copy is forwarded to the downstream ports, which may be a PE or a VM. A PE then forwards the packet to either of the two interfaces based on whichever one was present in the multicast tree chosen after deleting the ETAG. If the receiving PE identifies that the packet originated in either of the destination interfaces (whichever one is present in the multicast replication tree), since the Ingress-ECID value in the packet's ETAG is same as the ECID value of the interface, pruning is performed in which the packet is dropped without the copy being forwarded.

FIG. 7 illustrates one example of a multicast transmission for a dual-homed system. The multicast packet transmission at the upstream end from station S0 to a CB is equivalent to that described for unicast packet transmission from station S0 in FIG. 6, but utilizing the multicast rules described in reference to FIG. 5. In FIG. 7, station S3 connects directly to the one or both of the CBs, while S4 and S5 connect directly to LMS, without a PE. FIG. 7 also shows a situation where one of the stations is not configured for dual-homed operation. FIG. 2 shows station S2 connecting only through a single LM (LM6), so that a VTRUNK is not established for S2. Thus, in this example station S2 is not operating in a dual-homed mode, and the only physical path to a CB is through a single LM (LM6). However, system 200 is capable of operating having some stations configured for dual-mode operations, while other stations are configured for single-mode operations. Thus, in FIG. 7, where other stations are configured for dual-mode operation (using VTRUNK), other stations (such as S2) may be configured for single-mode operation (without using VTRUNK).

The same is also applicable for the unicast situation of FIG. 6. That is, either the upstream station or the downstream station may be configured for dual-homed mode, while the other is configured for the single-homed mode. Accordingly, in the implementation of the various embodiments of the invention, a system may be configured to operate as a dual-homed system, a single-homed system or a combination both schemes, where some end stations are configured for dual-homed operation, while others are configured for single-mode operations. The outgoing link may be viewed as a VTRUNK (having multiple physical pathways to a station) or not a VTRUNK (having one physical pathway to a station). The multiple physical links may be traced either to the end station or to an APE that interfaces to the station.

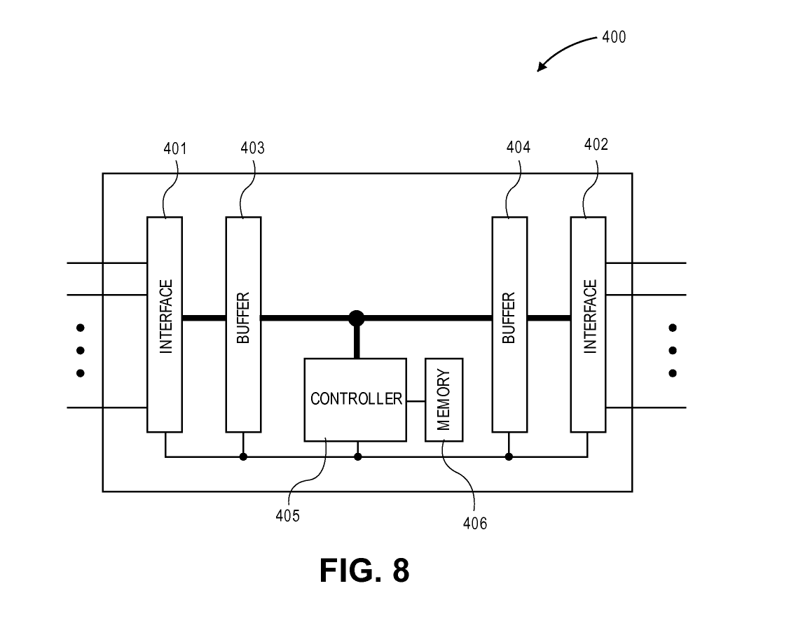

Although a variety of components and devices may be used for porting devices such as the above-described PEs and LMs, one embodiment is shown in FIG. 8. FIG. 8 shows a porting device 400, which may be a porting device, port extender, line module, line card, etc., for providing the hardware to perform the porting functions for the LMs and PEs described above. Device 400 includes an upstream interface 401 and a downstream interface 402 for receiving and transmitting data packets. A corresponding buffer 403 and 404 may be associated with the interface(s) to buffer the data. In some instances there may only be one buffer or no buffer at all. A controller, processor or processing circuitry 405, with associated memory 406, may provide the controlling function for porting and routing the data packets.

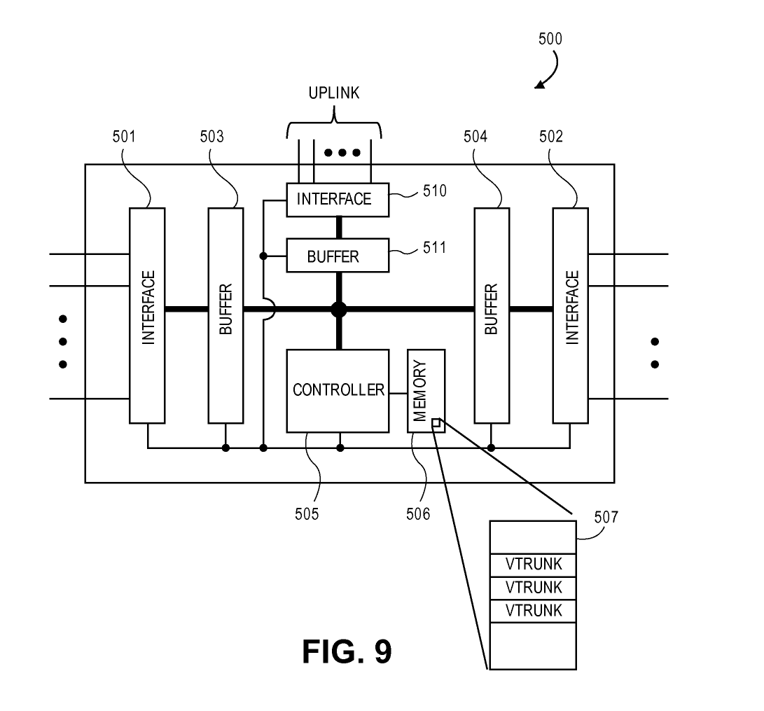

Likewise, FIG. 9 shows one embodiment for providing the CB as described above as device 500. Interfaces 501 and 502, with accompanying buffers 503 and 504 provide the receiving and transmitting of data packets. In some instances a single interface may be used for both receiving and transmitting to devices lower in the hierarchy. An uplink interface 510 and accompanying buffer 511 may provide the porting of data to uplink devices, components or network(s). Note that three buffers are shown, but one or any number may be used. In some instances there may not be a buffer. A controller, processor or processing circuitry 505, with associated memory 506, may provide the controlling function for porting and routing the data packets. In one embodiment, the VTRUNK information 507 that are used for routing packets to dual-homed stations as described above are retained in a portion of memory 506. It is to be noted that one or both of device 400 and device 500 may be integrated onto one or a plurality of integrated circuits, printed circuit boards, circuit cards, as well as other means for constructing circuits.

Accordingly, by associating a physical link information to a virtual port in the CB, a packet that is destined to a virtual interface may be reached through multiple physical links. A physical link resolution may come into play and a physical member selected according to member selection algorithm. If a packet is destined to a virtual interface that is connected to a single-homed PE, then the packet may go to a physical link connecting the CB and the LM. For dual-homed virtual interface, two separate physical pathways are allocated, where one or both pathways may be used to transfer a packet. However, the multiple pathways are viewed as a single virtual pathway by the system.

Furthermore, the above-described dual-homed mode of operation utilized two physical pathways. Other embodiments may readily adapt the dual-homed technique to provide for more than two physical pathways when configuring the aggregation grouping. Thus, the invention may be readily used for various multi-homed systems. Also, a system may be implemented strictly as a dual-homed (or multi-homed system) or a combination of single-homed and multi-homed system, so that some end points are connected as a single device and others are connected into an aggregation group.

Effectively, based on the destination virtual port in the CB, the CB may see the multiple physical links connecting the LMs via VTRUNKs and when the virtual interface is not dual homed, the physical links connecting the CB is seen as separate links. With the practice of the invention, multiple virtual ports may reside on the same physical links, but the combination of physical links to reach an end point may be different and may have different intermediate routing devices.

Thus, virtual trunking (or channeling) using multiple physical links is described. Furthermore, the example embodiments described herein utilized two physical links for a dual-homed system. However, other embodiments may use additional pathways to provide an X-homed system having X number of physical links assigned for a VTRUNK. The invention may be implemented in a variety of systems, including, but not limited to, trunk lines, enterprise systems, switch fabrics, etc. Furthermore, it is to be noted that the various connections shown in the Figures may be provided by wired connections, wireless connections or a combination of both. Additionally, the virtual trunking system shown may transfer a variety of data and not just packets.

The embodiments of the present invention have been described above with the aid of functional building blocks illustrating the performance of certain functions. The boundaries of these functional building blocks have been arbitrarily defined for convenience of description. Alternate boundaries could be defined as long as the certain functions are appropriately performed. One of ordinary skill in the art may also recognize that the functional building blocks, and other illustrative blocks, modules and components herein, may be implemented as illustrated or by discrete components, application specific integrated circuits, processors executing appropriate software and the like or any combination thereof.

As may also be used herein, the terms “controller”, “processor”, and/or “processing unit or circuit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information.

We claim:

1. A system comprising:
at least one controlling bridge;
a plurality of porting devices coupled to the at least one controlling bridge, in which the at least one controlling bridge and the plurality of porting devices are configured in an hierarchical arrangement with the plurality of porting devices lower in the hierarchical arrangement than the at least one controlling bridge; and
a plurality of endpoint devices coupled to the plurality of porting devices in the hierarchical arrangement to transfer data within the system, in which one endpoint device of the plurality of endpoint devices is configured to have a plurality of different physical paths to the at least one controlling bridge and in which the different physical paths are grouped together into a virtual trunk, wherein the at least one controlling bridge identifies the virtual trunk when transmitting the data from the at least one controlling bridge to the one endpoint device and selects one of the different physical paths to the one endpoint device to transfer the data to the one endpoint device.

2. The system of claim 1, wherein a plurality of controlling bridges are configured at a top of the hierarchical arrangement with the plurality of porting devices and the plurality of endpoint devices.

3. The system of claim 2, wherein the plurality of controlling bridges maintain identification of the virtual trunk and one of the plurality of controlling bridges to determine which physical path of the plurality of different physical paths of the virtual trunk to use in transferring data from the controlling bridge to the end point device.

4. The system of claim 3, wherein the plurality of porting devices includes a plurality of line modules coupled to the plurality of controlling bridges at a hierarchy level below the controlling bridges, wherein the different physical paths of the virtual trunk are configured using at least two line modules.

5. The system of claim 4, wherein the plurality of porting devices includes a plurality of port extending devices coupled to the plurality of line modules at a hierarchy level below the line modules.

6. The system of claim 5, wherein the one endpoint device is coupled to one of the plurality of port extending devices by a plurality of physical connection links.

7. The system of claim 5, wherein the data transfer from one of the controlling bridge is unicast data flow.

8. The system of claim 5, wherein the data transfer from one of the controlling bridge is multicast data flow.

9. The system of claim 1, wherein a second endpoint device within the system has only a single physical path to couple to the at least one controlling bridge, wherein the system operates having one or more endpoint devices coupled to the at least one controlling bridge via multiple physical paths and one or more endpoint devices coupled to the at least one controlling bridge via a single physical path.

10. An apparatus to operate as a bridging device comprising:
at least one data interface to couple to a plurality of porting devices, in which the apparatus and the plurality of porting devices are configured in an hierarchical arrangement with the plurality of porting devices lower in the hierarchical arrangement than the apparatus, and a plurality of endpoint devices coupled to the plurality of porting devices in the hierarchical arrangement to transfer data from the apparatus to one endpoint device of the plurality of endpoint devices; and
a controller coupled to the at least one data interface, wherein the controller is operable to configure a virtual trunk to have a plurality of different physical paths from the at least one data interface to the one endpoint device and to select one of the different physical paths to the one endpoint device to transfer the data to the one endpoint device.

11. The apparatus of claim 10, wherein the apparatus is configured at a top of the hierarchical arrangement with the plurality of porting devices and the plurality of endpoint devices.

12. The apparatus of claim 11, wherein the plurality of porting devices includes a plurality of line modules coupled to the apparatus at a hierarchy level below the apparatus and configured by the controller, wherein the different physical paths of the virtual trunk are configured using at least two line modules.

13. The apparatus of claim 12, wherein the plurality of porting devices includes a plurality of port extending devices coupled to the plurality of line modules at a hierarchy level below the plurality of line modules and configured by the controller.

14. The apparatus of claim 13, wherein the one endpoint device is coupled to one of the plurality of port extending devices by a plurality of physical connection links.

15. The apparatus of claim 10, wherein a second endpoint device within the hierarchical arrangement has only a single physical path to couple to the apparatus, wherein the apparatus operate within the hierarchical arrangement having one or more endpoint devices coupled to the at least one data interface via multiple physical paths and one or more endpoint devices coupled to the at least one data interface via a single physical path.

16. A method comprising:
configuring a bridge controller to operate with a plurality of porting devices that are coupled to the bridge controller, in which the bridge controller and the plurality of porting devices are configured in an hierarchical arrangement with the plurality of porting devices lower in the hierarchical arrangement than the bridge controller, and a plurality of endpoint devices coupled to the plurality of porting devices in the hierarchical arrangement to transfer data from the bridge controller to one endpoint device of the plurality of endpoint devices; and
configuring a virtual trunk to have a plurality of different physical paths from the bridge controller to the one endpoint device and to select one of the different physical paths to the one endpoint device to transfer the data to the one endpoint device.

17. The method of claim 16, further including configuring the plurality of porting devices to include a plurality of line modules coupled to the bridge controller at a hierarchy level below the bridge controller, wherein the different physical paths of the virtual trunk are configured using at least two line modules.

18. The method of claim 17, further including configuring the plurality of porting devices to include a plurality of port extending devices coupled to the plurality of line modules at a hierarchy level below the plurality of line modules.

19. The method of claim 18, further including configuring the one endpoint device to be coupled to one of the plurality of port extending devices by a plurality of physical connection links.

20. The method of claim 16, further including configuring a second endpoint device within the hierarchical arrangement to have only a single physical path to couple to the bridge controller, wherein the bridge controller operates within the hierarchical arrangement to have one or more endpoint devices coupled to the bridge controller via multiple physical paths and one or more endpoint devices coupled to the bridge controller via a single physical path.
